(19) United States
(12) Patent Application Publication
(10) Pub. No.: US 2012/0227535 A1
(43) Pub. Date: Sep. 13, 2012

(54) OPERATING UNIT FOR A MOTOR VEHICLE

(75) Inventor: Fredrik BACKMAN, Frankfurt am Main (DE)

(73) Assignee: GM GLOBAL TECHNOLOGY OPERATIONS LLC, Detroit, MI (US)

(21) Appl. No.: 13/415,919

(22) Filed: Mar. 9, 2012

(30) Foreign Application Priority Data
Mar. 11, 2011 (DE) 10 2011 013 664.9

(51) Int. Cl. B62D 1/04

(52) U.S. Cl. 74/552

(57) ABSTRACT

An operating unit is provided for a motor vehicle with a steering wheel that is rotatable about an axis. A finger-actuatable input unit is arranged on an arc extending around the axis.

### CROSS-REFERENCE TO RELATED APPLICATION

This application claims priority to German Patent Application No. 10 2011 013 664.9, filed Mar. 11, 2011, which is incorporated herein by reference in its entirety.

### TECHNICAL FIELD

The technical field relates to an operating unit for the controlling of a motor vehicle or respectively of equipment in a motor vehicle, in particular for the controlling of multimedia or respectively communications functions.

### BACKGROUND

The rapid development of digital cellular radio technology and of the internet has led to the fact that today a variety of communications and multimedia services is able to be used in motor vehicles which was still inconceivable a few years ago. Operating elements for the controlling of such services and functions require space on the instrument panel of a vehicle. It is not desirable to increase the extent of the instrument panel, in order to accommodate the necessary operating elements.

From DE 298 06 461 U1 an operating unit for a motor vehicle has become known, in which an input unit with a plurality of buttons is arranged on a steering wheel in the region of its impact absorber. This input unit in fact lies very centrally in the field of vision of a driver, but has the disadvantage that it is in the way of the unfolding of an airbag which is conventionally mounted in the steering wheel. In order to make the way free for the airbag, this conventional input unit is provided with a predetermined breaking point. An activation of the airbag therefore inevitably leads to the destruction of the input unit. If an airbag has been activated in an accident, the input unit must be replaced, which leads to unnecessarily increased repair costs for the owner of the vehicle. In addition to this is the fact that if, after a minor accident, in which the airbag has indeed been released, but the movement capability of the vehicle still exists, the functions which are controlled via the input unit are no longer available.

The numerous buttons of this conventional input unit are in fact not far distant from the steering wheel ring, on which the driver's hands are mostly situated during driving, but as long as the driver does not release his hands from the steering wheel ring, at best few of these buttons are respectively only able to be reached and actuated by the thumb, which makes the actuation of several buttons in succession for the input of a complex command protracted and onerous.

In view of the foregoing it is at least one object to provide an operating unit for a motor vehicle, which is readily accessible for the driver of the motor vehicle, without for this reason being affected by the activation of a steering wheel airbag. In addition, other objects, desirable features and characteristics will become apparent from the subsequent summary and detailed description, and the appended claims, taken in conjunction with the accompanying drawings and this background.

### SUMMARY

An operating unit is provided for a motor vehicle with a steering wheel rotatable about an axis and with at least one finger-actuatable input unit, which is arranged on an arc extending around the axis. When the steering wheel is rotatable about the axis independently of the arc, the position of the driver's hands relative to the input unit alters continuously owing to steering movements, even if the hands do not let go of the steering wheel. Therefore, various regions of the input unit are constantly accessible at a short distance for the driver's hands, so that in the course of time a great variety of the functions are able to be controlled by a minimal hand movement, and also commands that have a plurality of actuations of the input unit can be inputted comfortably.

Preferably, the arc is arranged on a side of the steering wheel facing away from the driver, in order to restrict as little as possible the driver's view onto the instrument panel and, if applicable, the possibility for unfolding of an airbag mounted in the steering wheel. The distance between the input unit and the steering wheel is preferably established in order to enable a touching of the input unit by a finger, in particular an index or middle finger, of a hand, the heel of which hand is lying on the steering wheel. This distance is typically between approximately 5 and approximately 10 cm. The driver can thus actuate the input unit without, in so doing, having to release his hands from the steering wheel. For the same purpose, it is also expedient that the radius of the arc corresponds to the radius of the steering wheel.

The operating unit should expediently comprise a display screen which can deliver to the driver information concerning operating parameters of the vehicle and/or confirmation of adjustments that have been carried out by him on the input unit. Such a display screen should be arranged centrally in the field of vision of the driver and is therefore expediently visible through an opening of the steering wheel. The display screen can be arranged in particular in the instrument panel or else in front of the instrument panel in a mounting of the arc-shaped input unit.

In order to facilitate for the driver the choice between functions which are able to be controlled through the operating unit, the display screen is preferably arranged to indicate a plurality of symbols associated respectively with these functions, between which a choice is able to be made by means of the input unit. In order to enable the choice between functions, the input unit can be arranged to detect the direction of a movement of a finger over its surface, and the display screen can be arranged to display the symbols in a predetermined sequence and, depending on the detected movement direction, to switch over from a currently selected symbol to its predecessor or successor (in relation to the said sequence) as the selected symbol.

The selected symbol can be displayed on the display screen expediently in a manner which is emphasized with respect to non-selected symbols, e.g. brighter or larger than a non-selected symbol, with a different kind of background than non-selected symbols, in color instead of levels of gray, with stronger color saturation than non-selected symbols, or suchlike. Another possibility is to display the respectively selected symbol at a location which is emphasized with respect to the display sites of non-selected symbols, e.g. in the middle of a row of symbols or at the highest point of an arc on which the displayed symbols are arranged. In particular, in the case of symbols of alphanumeric type, it can be expedient that respectively only a limited number thereof, the selected symbol and some of its predecessors and successors, are visible on the display screen, wherein in fact the selected symbol can change owing to a user input, but not its position on the display screen.

In particular, when a choice has to take place between a small number of symbols, the input unit can be expediently arranged to detect the site of a contact by the finger and to select from symbols displayed on the display screen one whose location on the display screen corresponds to the location of the contact. In order to ensure a large-format, comfortably readable presentation, the display screen can be switchable between a display mode in which operating parameters of the motor vehicle are displayed at least on a portion of the display screen, and a display mode in which on this portion of the display screen inputs are reflected which have been carried out on the input unit. As an input unit, in particular a so-called touch panel, known from mobile computers, comes into consideration.

### BRIEF DESCRIPTION OF THE DRAWINGS

The present invention will hereinafter be described in conjunction with the following drawing figures, wherein like numerals denote like elements, and:

FIG. 1 a diagrammatic perspective view of an operating unit according to a first embodiment of the invention;

FIG. 2 a side view of the driver in front of the operating unit of FIG. 1;

FIG. 3 a view of an operating unit analogous to FIG. 1 according to a second embodiment of the invention;

FIG. 4 the view of the driver onto the operating unit in a first display mode;

FIG. 5 the view onto the operating unit in a second display mode;

FIG. 6 the operating unit during the selecting of a character which is to be inputted; and

FIG. 7 the operating unit at the moment of the definitive choice of the character.

### DETAILED DESCRIPTION

The following detailed description is merely exemplary in nature and is not intended to limit application and uses. Furthermore, there is no intention to be bound by any theory presented in the preceding background or summary or the following detailed description.

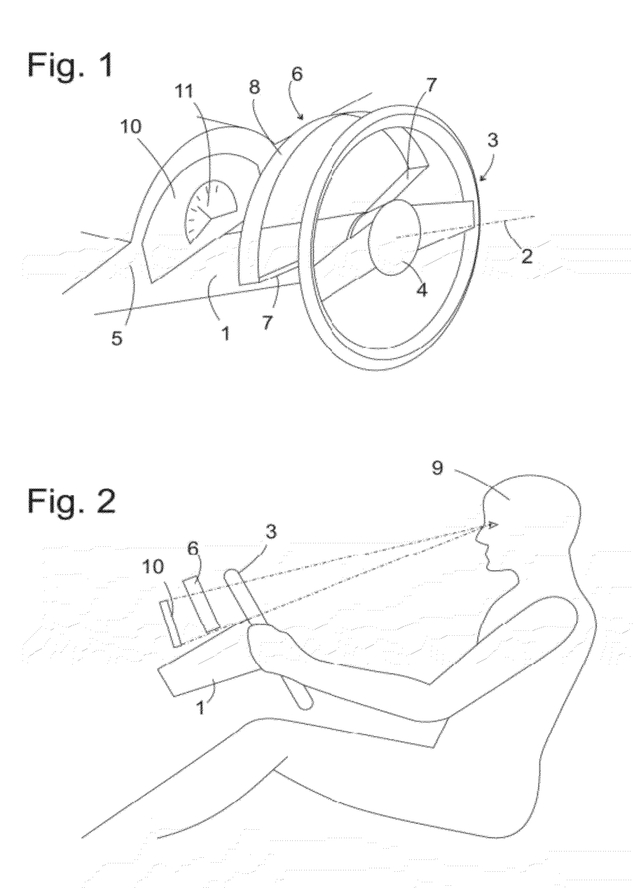

FIG. 1 shows the operating unit according to an embodiment in a diagrammatic side view. It comprises, in a manner familiar to the specialist in the art, a steering column 1 with a steering wheel 3 mounted rotatably thereon about an axis 2. The steering wheel 3 can have a central impact absorber 4, which can serve to accommodate an airbag.

Between the steering wheel 3 and an instrument panel 5 of a motor vehicle, an input unit 6 is fastened to the steering column 1 via two struts 7 running radially to the axis 2. The input unit is arc-shaped with a radius which corresponds substantially to that of the steering wheel 3. The arc of the input unit 6 is centered on the axis 2, and the distance between the steering wheel 3 and the input unit 6 in the direction of the axis 2 is between 5 and 10 cm, so that a driver, without releasing the thumb and heel of his hands from the steering wheel 3, can touch with one of the other fingers of each hand an outer peripheral surface of the input unit 6. The arc extends around the axis 2 over an angle of somewhat less than 180°, so that space remains beneath the ends of the arc for actuating levers for turn signals and windshield wipers, not illustrated in FIG. 1, mounted in a manner known per se lying opposite each other on the steering column 1.

The peripheral surface 8 of the input unit 6 can be equipped with a plurality of switches or touch sensors; preferably, it is constructed in the manner of a touchpad known from mobile computers, which allows the site of a movement by a finger of the driver, the direction of a movement of a finger on its surface and/or the pressure exerted by the finger onto the surface to be detected. The arc-shaped input unit 6 and the struts 7 form a window through which the driver 9 of the motor vehicle can look onto a display screen 10 on the instrument panel 5, as illustrated in FIG. 2.

In addition to a matrix display device suited to the displaying of freely programmable graphic contents, the display screen 10 can also comprise conventional analog indicator display instruments for displaying operating parameters of the vehicle such as for instance speed, number of revolutions of the engine, cooling water temperature, filling level of the fuel tank etc. Preferably, the entire display screen 10 is filled by a matrix display device, and this can be arranged at least in a normal driving operation mode on a majority of its surface to simulate indicator display instruments for displaying the above-mentioned operating parameters, i.e., images 11 of indicator display instruments, in which the position of an imaged indicator depicts the value of the associated operating parameter.

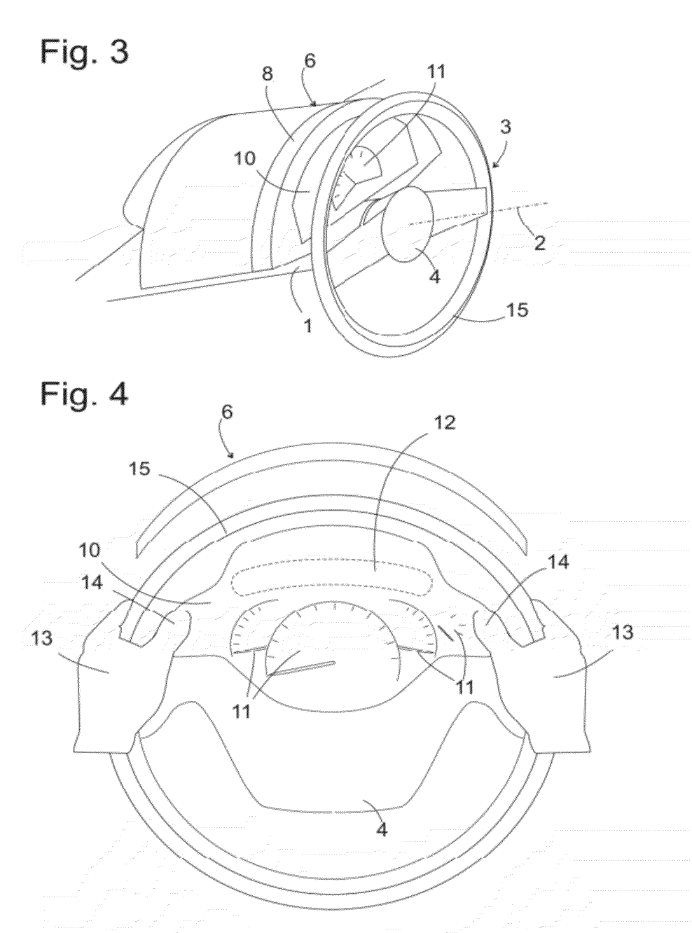

FIG. 3 shows a modification of the operating unit, in which the display screen 10 is moved towards the steering wheel 3 into the height of the input unit 6, so that the peripheral surface 8 of the input unit 6 extends in the arc around the display screen 10. Owing to the small distance between the display screen 10 and the steering wheel 3, the angle here is greater from which the displays 11 on the display screen 10 are visible through the opening of the steering wheel 3. The display screen 10 can therefore have large dimensions, without the risk existing that an upper region of the steering wheel ring conceals a portion of the display screen 10 from the eyes of a tall driver.

FIG. 4 shows an image of the operating unit as it presents itself to the driver 9 during normal driving. Through the opening of the steering wheel 3, various images 11 of indicator instruments are visible, on which operating data such as speed of travel, number of revolutions etc. are able to be read; an area 12 of the display screen 10 above the images 11 is unused. The orientation of the steering wheel 3 in FIG. 4 corresponds to driving straight ahead. The driver's hands 13 are situated in a symmetrical normal position on both sides of the display screen 10. The thumbs 14 grip into the opening of the steering wheel 3, whilst the remaining fingers respectively embrace the steering wheel ring 15 on the exterior. The input unit 6 extends in an arc shape behind the steering wheel ring 15. In the position which the hands 13 have in FIG. 4, the tips of the index fingers, when the driver extends them, comfortably reach the turn signal- or respectively windshield wiper lever, and potentially just reach the left or respectively right edge of the input unit 6.

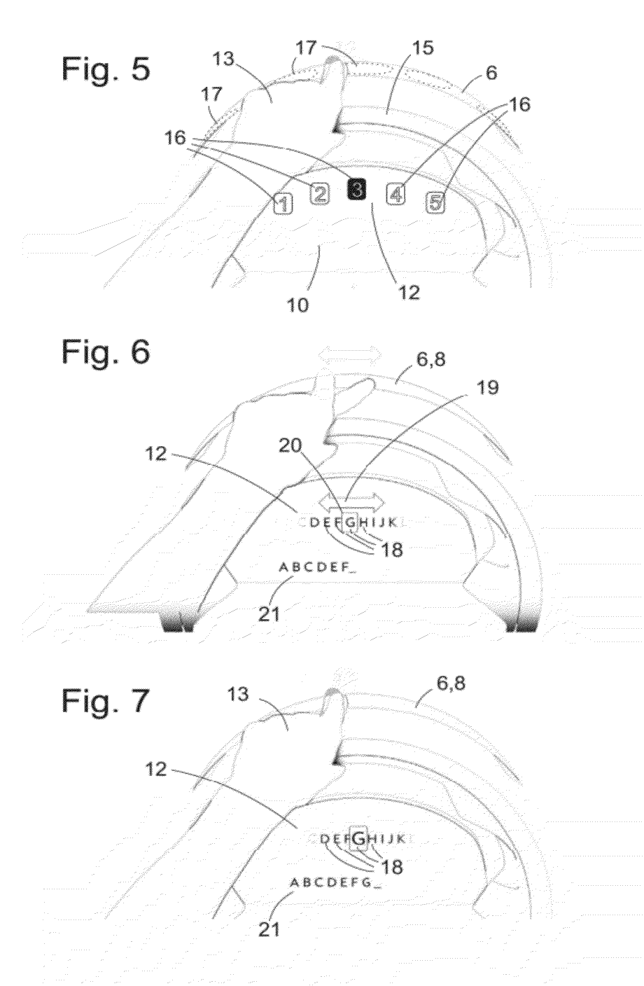

In order to actuate the input unit 6, the driver 9 moves a hand 13 on the steering wheel, as shown in FIG. 5. By, for example, moving his left hand 13 upwards and towards the middle on the steering wheel ring 15, he can comfortably reach the input unit 6 with the tip of his left index finger, without having to let go of the steering wheel 3 to do so. The display screen 10 reacts to the contact of the input unit 6 by the finger by a group of symbols 16 appearing in the previously unused area 12 of the display screen 10. The images 11 of the indicator instruments, although not illustrated in FIG. 5, can continue to be visible on the display screen 10 at this stage.

In FIG. 5, for simplicity, numbers framed by boxes are represented as symbols 16; in practice, rather, pictograms of the functions which are to be selected via the respective symbols 16 will be chosen as symbols, such as and for example, those known from the user surfaces of cell phones. This means that, for example, a symbol whose selection enables access to a directory of telephone numbers or email addresses can depict a book, a symbol in the form of an envelope stands for the displaying or creating of email or SMS messages, a telephone for cellular telephony, etc.

As long as the number of symbols 16 which are displayed simultaneously is not too great, e.g., not greater than five, as illustrated in FIG. 5, a region 17 on the surface of the input unit 6 can be associated with each of the symbols 16 in accordance with its arrangement on the display screen 10, the touching of which region by the driver amounts to a selection or choice of the respective symbol 16. In the illustration of FIG. 5, the driver's index finger is touching a central region 17, corresponding to the selection of the central symbol 16. This consequently appears on the display screen 10 in an emphasized presentation with respect to the remaining symbols 16, in order to display the selected status of the symbol. By means of the emphasis, the driver can check whether his input has been understood correctly. By a second touching of the region 17, the driver confirms that he wishes to activate the function corresponding to the selected symbol 16, e.g. the writing of an SMS.

The pictographic symbols 16 now disappear; instead of these, as shown in FIG. 6, other symbols 18 appear in the area 12, namely a portion of the alphabet and a double arrow 19, which is intended to make it clear to the driver that by stroking with his finger over the peripheral surface 8 in a clockwise direction or in an anti-clockwise direction, he can scroll through the displayed letters 18 in a forward or backward direction. The letter 18 in the center of the area 12, emphasized here by a frame 20, is selected. By the driver stroking over the input unit 6 with his finger, he can move the row of letters 18 towards the left or right and can thus alter the respectively selected letter. By tapping or firmly pressing with his finger onto the input unit 6, the driver confirms a selected letter, which the display screen 10, as shown in FIG. 7, acknowledges by a briefly enlarged presentation of the respective letter. Letters 21, which the driver has selected successively in this way and which reproduce the current status of the SMS, appear on the display screen 10 beneath the area 12 where, during normal travel, the images 11 of the scale instruments are to be seen. These images 11 are completely hidden in the operating state of the display screen 10 shown in FIG. 6 or 7; however, it would also be conceivable to leave them visible with reduced contrast or contrasted by color against the selected letters 21 of the SMS.

The same operating principle of stroking over the input unit 6 or respectively tapping or pressing can also be used in order to compile a telephone number from displayed digits or in order to select a desired communication partner from an organized list of stored telephone numbers or addresses. The input unit 6 is able to be used for the controlling of numerous other functions in a motor vehicle which are not described in detail here. For example, the type of input of letters described above can be used in order to input a destination into a vehicle navigation system. The controlling of a car radio is also possible by means of the input unit 6. Thus, for example, one of the symbols 16 of FIG. 5 can represent the car radio. If this is selected, a new set of symbols can be displayed, which respectively stand for various reception frequency ranges and/or various audio signal sources, between which the choice can be made as in the case of the symbols 16 by touching an associated surface region of the input unit 6 or, as in the case of the symbols 18, by stroking with the finger. By means of the direction of stroking with the finger, in addition the direction of a broadcast station search run can be established or a broadcast station can be selected from a list.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An operating unit for a motor vehicle, comprising:
a steering wheel rotatable about an axis; and
a finger-actuatable input unit arranged on an arc that extend around the axis.

2. The operating unit according to claim 1, wherein the steering wheel is rotatable about the axis independently of the finger-actuatable input unit.

3. The operating unit according to claim 1, wherein the finger-actuatable input unit is arranged on a side of the steering wheel facing away from a driving position.

4. The operating unit according to claim 1, wherein a distance between the finger-actuatable input unit and the steering wheel is established in order to enable a touching of the finger-actuatable input unit by a finger of a hand and a ball of hand lies on the steering wheel.

5. The operating unit according to claim 1, wherein a radius of the arc corresponds to a wheel radius of the steering wheel.

6. The operating unit according to claim 1, further comprising display screen.

7. The operating unit according to claim 6, wherein the display screen is visible through an opening of the steering wheel.

8. The operating unit according to claim 6, wherein the display screen is arranged to display a plurality of symbols between which a choice selectable with the finger-actuatable input unit.

9. The operating unit according to claim 8,
wherein the finger-actuatable input unit is arranged to detect a direction of a movement of a finger over an input unit surface, and
wherein the display screen is arranged to display the plurality of symbols in a sequence and as a function of a detected movement direction to switch from a currently selected symbol to a predecessor symbol a selected symbol.

10. The operating unit according to claim 9, wherein the display screen is arranged to display the selected symbol in an emphasized manner.

11. The operating unit according to claim 9, wherein the display screen is arranged to display the selected symbol at an emphasized site.

12. The operating unit according to claim 8, wherein the finger-actuatable input unit is arranged to detect a site of a contact by a finger and to select from displayed symbols on the display screen a display screen site on the display screen that corresponds to the site of the contact.

13. The operating unit according to claim 6,
wherein the display screen is configured to switch between a first display mode and a second display mode,
wherein the first display mode comprises display of operating parameters of the motor vehicle at least on a portion of the display screen, and
wherein the second display mode comprises display on a portion of input to the display screen carried out on the finger-actuatable input unit.

14. The operating unit according to claim 1, wherein the finger-actuatable input unit is a touch panel.
